(19) United States
(12) Patent Application Publication
(10) Pub. No.: US 2023/0421595 A1
(43) Pub. Date: Dec. 28, 2023

(54) NETWORK CONTROL APPARATUS, NETWORK SYSTEM, NETWORK CONTROL METHOD, AND NON-TRANSITORY COMPUTER-READABLE MEDIUM

(71) Applicant: NEC Corporation, Minato-ku, Tokyo (JP)

(72) Inventors: Shohei MITANI, Tokyo (JP); Hirofumi UEDA, Tokyo (JP); Taniya SINGH, Tokyo (JP)

(73) Assignee: NEC Corporation, Minato-ku, Tokyo (JP)

(21) Appl. No.: 18/039,208

(22) PCT Filed: Dec. 2, 2020
(86) PCT No.: PCT/JP2020/044860

§ 371 Date: May 26, 2023

(51) Int. Cl. H04L 9/40

(52) U.S. Cl. CPC H04L 63/1433

(57) ABSTRACT

A network control apparatus (10) according to the present disclosure is a network control apparatus (10) configured to control a node included in a network, and the network control apparatus (10) includes a collecting unit (11) configured to collect data pertaining to a node included in a network, a calculating unit (12) configured to calculate a security index pertaining to a threat of the node based on the data collected by the collecting unit (11), and a determining unit (13) configured to determine a zone of the node based on the security index calculated by the calculating unit (12).

### TECHNICAL FIELD

The present invention relates to network control apparatuses, network systems, network control methods, and non-transitory computer-readable media.

### BACKGROUND ART

Security threats are on the rise in recent years as network systems become more diverse and more complex. New threats continue to increase, and techniques for protecting network systems from various threats are in demand.

As related art, Patent Literature 1 or Non Patent Literature 1, for example, is known. Patent Literature 1 describes the filtering of packets of a zone related to a security domain in a layer 2 device provided with a firewall engine. Non Patent Literature 1 describes the switching of zones in a control device in accordance with the operation state of an industrial control system.

### CITATION LIST

### Patent Literature

Patent Literature 1: Published Japanese Translation of PCT International Publication for Patent Application, No. 2005-505175

### Non Patent Literature

Non Patent Literature 1: Wataru Machii, Isao Kato, Masahito Koike, Masafumi Matta, Tomomi Aoyama, Hidemasa Naruoka, Ichiro, Koshijima, and Yoshihiro Hashimoto, “Dynamic Zoning Based on Situational Activitie for ICS Security,” the 10th Asian Control Conference 2015 (ASCC 2015), pp. 1242-1246, (2015-05).

### SUMMARY OF INVENTION

### Technical Problem

Related art such as Patent Literature 1 or Non Patent Literature 1 enables control of a network with use of firewalls or control of a network in accordance with the system state. However, if, for example, a threat arises within a network, such related art may have difficulty appropriately responding to a change in the threat.

In view of such circumstances, the present disclosure is directed to providing a network control apparatus, a network system, a network control method, and a non-transitory computer-readable medium capable of appropriately responding to a change in a threat within a network.

### Solution to Problem

A network control apparatus according to the present disclosure includes collecting means for collecting data pertaining to a node included in a network, calculating means for calculating a security index pertaining to a threat of the node based on the collected data, and determining means for determining a zone of the node based on the calculated security index.

A network system according to the present disclosure includes a node included in a network, and a network control apparatus controlling the network, and the network control apparatus includes collecting means for collecting data pertaining to the node, calculating means for calculating a security index pertaining to a threat of the node based on the collected data, and determining means for determining a zone of the node based on the calculated security index.

A network control method according to the present disclosure includes collecting data pertaining to a node included in a network, calculating a security index pertaining to a threat of the node based on the collected data, and determining a zone of the node based on the calculated security index.

A non-transitory computer-readable medium according to the present disclosure is a non-transitory computer-readable medium storing a program for causing a computer to execute processing of collecting data pertaining to a node included in a network, calculating a security index pertaining to a threat of the node based on the collected data, and determining a zone of the node based on the calculated security index.

### Advantageous Effects of Invention

The present disclosure can provide a network control apparatus, a network system, a network control method, and a non-transitory computer-readable medium capable of appropriately responding to a change in a threat within a network.

### BRIEF DESCRIPTION OF DRAWINGS

FIG. 1 is a configuration diagram illustrating a configuration example of a related network system.

FIG. 2 is a configuration diagram illustrating an outline of a network control apparatus according to an example embodiment.

FIG. 3 is an illustration for describing an outline of a network control apparatus according to an example embodiment.

FIG. 4 is an illustration for describing an advantageous effect of a network control apparatus according to an example embodiment.

FIG. 5 is a configuration diagram illustrating a configuration example of a network system according to a first example embodiment.

FIG. 6 is a flowchart illustrating a control method of the network system according to the first example embodiment.

FIG. 7 illustrates a data example of the network system according to the first example embodiment.

FIG. 8 is an illustration for describing a control method of the network system according to the first example embodiment.

FIG. 9 is a configuration diagram illustrating an outline of hardware of a computer according to an example embodiment.

### EXAMPLE EMBODIMENT

Hereinafter, some example embodiments will be described with reference to the drawings. In the drawings, identical elements are given identical reference characters, and their repetitive description will be omitted as necessary.

### Examination Leading to Example Embodiment

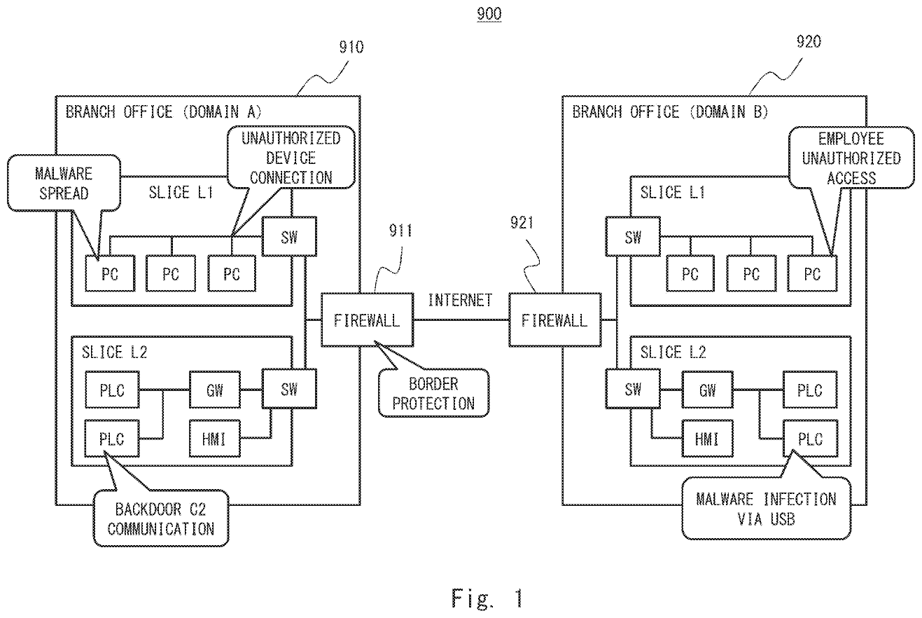

FIG. 1 illustrates a configuration example of a related network system to which an example embodiment is not applied. A related network system 900 is, for example, an enterprise network in a company, a plant, a factory, or the like. The related network system 900 includes, for example, a plurality of network domains (may also be referred to simply as domains) provided in different offices, and the plurality of domains are interconnected via the internet. Furthermore, networks within the domains are separated by slicing adopted, for example, in 5G, in accordance with the types of Quality of Service (QoS) requests, such as high-capacity communication or low-latency communication.

In the example shown in FIG. 1, the network system 900 includes a domain A of a branch office 910 and a domain B of a branch office 920. The domains A and B include respective firewalls 911 and 921 at the borders of the respective networks, and the domains A and B are connected to the external internet via the firewalls 911 and 921. Furthermore, the domains A and B are each separated into a slice L1 and a slice L2. For example, the slices L1 are each a slice for high-capacity communication and each include a switch (SW) and a plurality of personal computers (PCs). The slices L2 are each a slice for low-latency communication and each include a SW, a gateway (GW), a human-machine interface (HMI), and a plurality of programmable logic controllers (PLCs). The firewalls 911 and 921 have security policies (may also be referred to simply as policies) set therein in advance, and the firewalls 911 and 921 apply a policy rule to a packet relayed at the network border and take an action such as approving or rejecting the packet.

As the inventors have examined a network system having a configuration such as the one shown in FIG. 1, however, the inventors have found that the border protection by firewalls may not be able to respond to a threat that arises dynamically within a network. Specifically, while a firewall can protect an internal network (domain) from a threat coming from the external internet, a firewall cannot respond to a threat that arises within a network.

As indicated in FIG. 1, threats within a network include, for example, malware infection of a device within a network via a universal serial bus (USB), spread of malware from an infected device within a network, an attack by backdoor command and control (C2) communication, connection of an unauthorized device to an internal network, or unauthorized access by a malicious employee who has had his or her privileges escalated by operating a PC within a network. These instances cannot be handled appropriately simply with a firewall.

Therefore, general network access control and rigorous network access control are examined as related network access control. In one possible method in general network access control, a plurality of policy rules are applied to a packet, and an action of approving or rejecting the packet or other actions are taken. For example, in a 5G network, a packet in the user plane is classified through matching against a packet detection rule (PDR), and an action to be taken is determined by referring to an action rule (such as FAR) corresponding to the separation. However, even if a plurality of policy rules are applied, as in the general network access control, since the policy rules (conditions and actions) are fixed, a change in a threat cannot be handled.

Meanwhile, in one possible method in rigorous network access control, the state of a network is monitored, and a policy to be applied is changed dynamically in accordance with the state of the network. Elements to be monitored include, for example, IP addresses or MAC addresses as well as various other elements such as users, suppliers of devices, applications, positions, behaviors, or histories. Herein, in one conceivable method, a trust score (reliability) of each user, device, or application is calculated, and a policy is determined based on the trust score. However, even if a policy is determined simply based on the trust score, the number of combinations of elements, including transmitter/receiver combinations, is enormous, and policies to be applied vary, which makes the managing difficult.

In this respect, as a method of facilitating management of policies, security zone control, such as the one disclosed in Patent Literature 1 or Non Patent Literature 1, is conceivable. In security zone control, an entity is divided into a plurality of security zones (may also be referred to simply as zones), and different policies are applied to different zones. Even when a policy is changed dynamically in accordance with a circumstance, the same policy is applied to the same zone, and this facilitates the managing. For example, as disclosed in Non Patent Literature 1, firewalls are provided between zones, and policies for the zones are set in the firewalls. Even in this case, however, the zones are fixed, and thus the ability to respond to a change in a threat is limited.

Meanwhile, as disclosed in Non Patent Literature 1, a method of dynamically controlling a security zone is also conceivable. For example, according to Non Patent Literature 1, the zone of the control device is switched in accordance with the operation state of the industrial control system. Even in this case, however, the patterns of change of the zone need to be determined in advance, and this method is not versatile. In other words, since this method only controls the zone in accordance with the operation state of the industrial control system, policies cannot be controlled in accordance with a change in a threat.

Accordingly, an example embodiment provides network access control that, by dynamically controlling zones, can protect important information, equipment, or a user from even a threat within a network to minimize damage.

### Outline of Example Embodiment

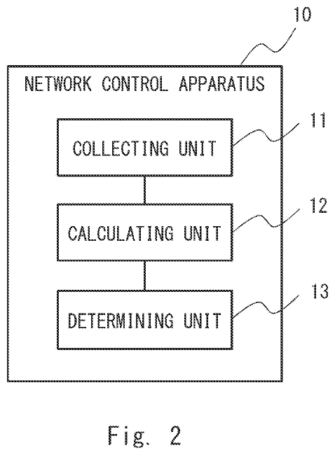

FIG. 2 illustrates an outline of a network control apparatus according to an example embodiment. As illustrated in FIG. 2, a network control apparatus 10 according to an example embodiment includes a collecting unit 11, a calculating unit 12, and a determining unit 13.

The collecting unit 11 collects data pertaining to a node included in a network. The calculating unit 12 calculates a security index pertaining to a threat of the node, based on the data collected by the collecting unit 11. The determining unit 13 determines a zone of the node based on the security index calculated by the calculating unit 12. This configuration makes it possible to dynamically control a zone in accordance with a threat and, for example, to provide an appropriate protection against a threat within a network.

In the example embodiment, a zone is a unit that shares a policy and does not indicate a border of access restriction. In other words, a zone border alone does not restrict access. In a more specific example, such policies can be set in which, for example, when there are zones A to C, all communications except the HTTPS communication are prohibited in the communication within the zone A and in the communication from the zone A to the other zones, only the users with high authority can communicate within the zone B, only queries from the zone B to the zone C and responses to the queries are permitted between the zone B and the zone C, and all communications are permitted within the zone C.

Furthermore, in the example embodiment, a node is, for example, an entity that corresponds one-to-one to a host name. Additionally, a node may correspond to a device or, for example, to a combination of a host, a device, and a user. In the following description according to the example embodiment, a target to be monitored is mainly a host, but the example embodiment can be applied to other nodes besides a host.

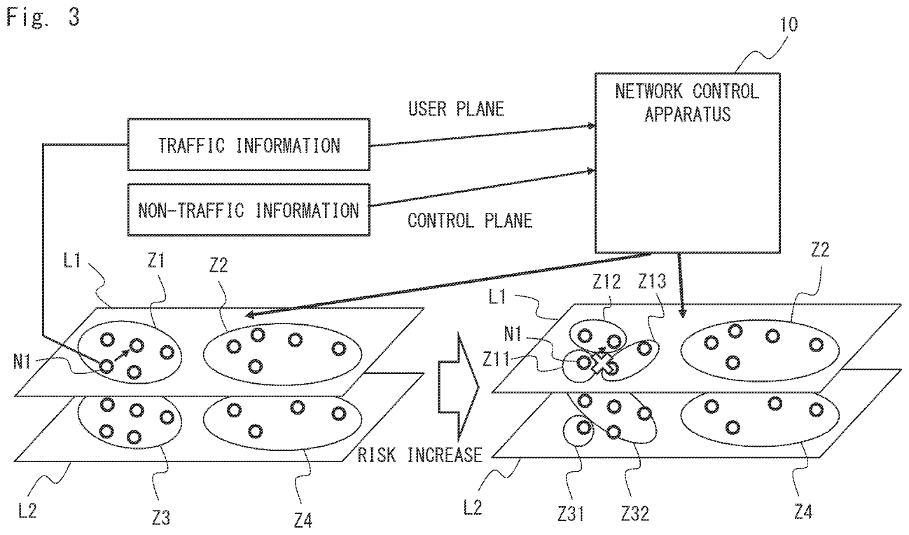

FIG. 3 illustrates a specific example of a control method performed by a network control apparatus according to an example embodiment. A network control apparatus 10 collects, as information pertaining to a node, for example, traffic information via a user plane and non-traffic information, such as authentication information or history, via a control plane. The network control apparatus 10 calculates an index (security index) based on the collected information, subdivides a zone in accordance with a heightening of a threat, and changes policies to be applied between zones. For example, the network control apparatus 10 calculates, as the index, for example but not limited to, a trust score or a performance requirement score from information pertaining to the nodes as a whole and the network as a whole. For example, a set of correspondence between the scores and the policies, zone dividing policies, and action policies is set in advance, and the division of a zone and policies between the zones is determined based on the calculated score.

In the example shown in FIG. 3, the network is separated into a slice L1 and a slice L2. Herein, the slice L1 and the slice L2 are virtually separated networks, and the nodes in the slice L1 and the nodes in the slice L2 are virtually different nodes but may be physically the same nodes. For example, zones Z1 and Z2 are set in the slice L1, and zones Z3 and Z4 are set in the slice L2. Policies are set such that communication between zones, such as between the zones Z1 and Z2 or between the zones Z3 and Z4, is strictly restricted. At this point, information pertaining to a node N1 in the zone Z1 may be collected, and the collected information may lead to a decrease in the reliability of the node N1 or the reliability of the zones Z1 and Z3. In this case, the risk at the node N1 or the zones Z1 and Z3 is determined to have increased, and the zones Z1 and Z3 are each divided. For example, the zone Z1 is divided into a zone Z11 that includes only the node N1 and zones Z12 and Z13, and the zone Z3 is divided into a zone Z31 that includes only the node corresponding to the node N1 and a zone Z32. Moreover, a policy is set to strongly restrict the communication in the zone Z 11 that includes the node N1, and a policy is set to somewhat strongly restrict the communication in the other zones Z12, Z13, Z31, and Z32. This setting makes it possible to prevent the spread of damage not only between the original zones held before the zone division but also within the zones held after the zone division, in response to a threat that has arisen at the node N1.

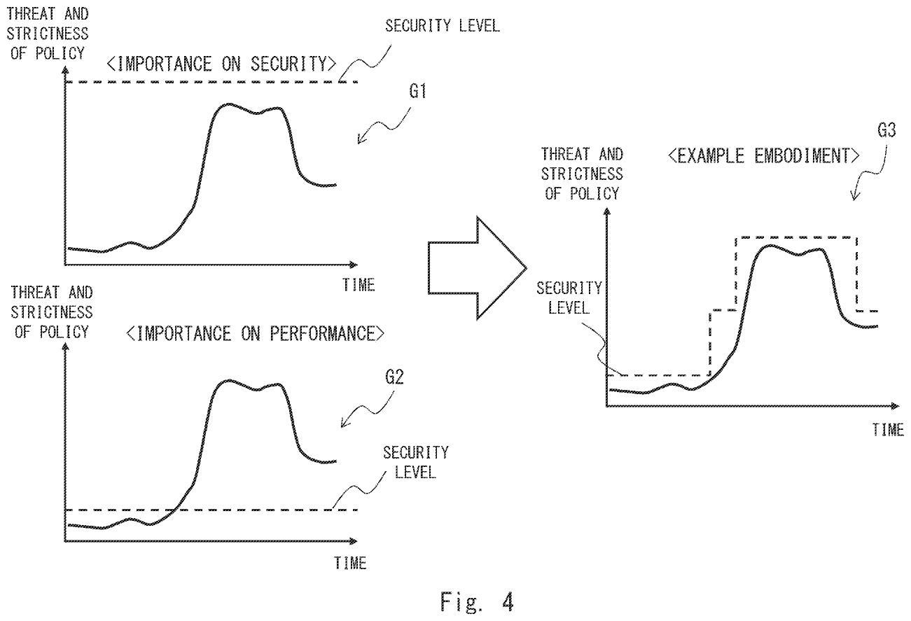

FIG. 4 illustrates an advantageous effect of the control method performed by the network control apparatus according to the example embodiment. For example, before the example embodiment is applied, a control method places importance on either the security or the performance.

In the case of a control method that places importance on the security, as indicated by the graph G1, the security level of a policy is set high. Therefore, the same policy is applied even when, for example, the number of accesses to a specific host from the outside has increased and the risk of a threat has heightened. In other words, the communication is restricted at the same level both when the number of accesses is low (the threat is low) and when the number of accesses is high (the threat is high). Therefore, although high security is ensured in both cases, the performance of the communication cannot be increased since the communication is restricted uniformly.

Meanwhile, in the case of a control method that places importance on the performance, the security level of a policy is set low. Therefore, no policy is applied when, for example, the number of accesses to a specific host from the outside has increased and the risk of a threat has heightened. In other words, although the communication is restricted at a high level when the number of accesses is low (the threat is low), the communication is not restricted when the number of accesses is high (the threat is high). Therefore, although high performance can be achieved, a threat may not be handled since the communication is not restricted.

In this respect, the example embodiment makes it possible to adjust the security level in accordance with the circumstances, as indicated by the graph G3. In other words, the security level is set low when the number of accesses is low (the threat is low), and the security level is set high when the number of accesses is high (the threat is high). This configuration makes it possible to control policies dynamically in accordance with a threat and to achieve both the security and the performance.

### First Example Embodiment

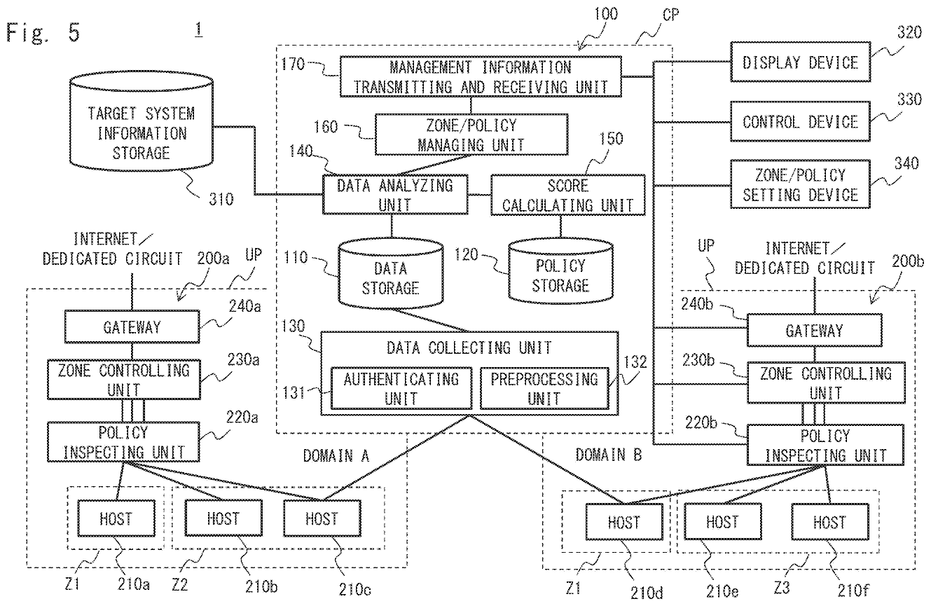

Now, a first example embodiment will be described with reference to the drawings. FIG. 5 illustrates a configuration example of a network system according to the present example embodiment. A network system 1 according to the present example embodiment is a system that constitutes, for example, an enterprise network, as with the system shown in FIG. 1, but the network system 1 may be any other network system. As illustrated in FIG. 5, the network system 1 according to the present example embodiment includes a user plane UP that transports user data and a control plane CP that transports control data (control signal) that controls the user plane UP. In the network system 1, the control plane CP specifies zones and policies for the user plane UP and inspects (monitors) any threat in the user plane UP.

The user plane UP includes a network communication unit 200 that constitutes a network domain. For example, the user plane UP includes a network communication unit 200a of a domain A and a network communication unit 200b of a domain B. Herein, the number of domains may be set as desired. The network communication units 200a and 200b each include hosts 210 (210a to 210c and 210d to 210f, respectively), a policy inspecting unit 220 (220a and 220b, respectively), a zone controlling unit 230 (230a and 230b, respectively), and a gateway 240 (240a and 240b, respectively). For example, a zone Z1 is set in the domains A and B, and the zone Z1 includes the host 210a and 210d. Meanwhile, a zone Z2 is set in the domain A, and the zone Z2 includes the host 210b and 210c. A zone Z3 is set in the domain B, and the zone Z3 includes hosts 210e and 210f. Herein, the plurality of hosts 210 may be divided into a plurality of slices, as with the configuration shown in FIG. 1 or 3.

The control plane CP includes a network controlling unit 100 that controls the network in the user plane UP (network communication units 200). The network controlling unit 100 collects data from the network and the hosts, calculates an index (security index) from the collected data, and determines zones based on the calculated index. Furthermore, the network controlling unit 100 performs clustering of indices and performs zoning of the hosts such that hosts with close policies are grouped together.

The network controlling unit 100 includes a data storage 110, a policy storage 120, a data collecting unit 130, a data analyzing unit 140, a score calculating unit 150, a zone/policy managing unit 160, and a management information transmitting and receiving unit 170. Herein, the network controlling unit 100 may have a different configuration as long as the network controlling unit 100 can implement a control method according to the present example embodiment.

Additionally, the network system 1 includes, for example, a target system information storage 310, a display device 320, a control device 330, and a zone/policy setting device 340. The target system information storage 310 stores target system information, such as operation information of the network system 1 (target system). The display device 320 displays, for example, information that the network controlling unit 100 has collected from the user plane UP (network communication units 200) or information about zones and policies to be set. The control device 330 performs control necessary for operating the user plane UP. The zone/policy setting device 340 sets zones or policies to the user plane UP in accordance with the control of the network controlling unit 100. Herein, these devices may be included in the user plane UP or the control plane CP or may be provided outside the user plane UP or the control plane CP.

### <Configuration of User Plane>

A host 210 is a device whose security is to be monitored and is monitored (controlled) by the network controlling unit 100 of the control plane CP. The network controlling unit 100 monitors communication by the host 210 in the user plane UP. The host 210 is an information processing device or a communication device and is, for example but not limited to, a computer, a server, or an edge gateway. The host 210 may be a physical host or a virtual host. Furthermore, the host 210 may connect another device to be monitored to a lower-order subnetwork. The host 210 communicates with the internet via another host 210 or the gateway 240 in the user plane UP and transmits data to the data collecting unit 130 in the control plane CP.

The policy inspecting unit 220 applies a policy to each zone in the user plane UP. The policy inspecting unit 220 selects a policy to be applied to a zone, inspects a packet transmitted or received in the user plane UP in accordance with the applied policy, and takes an action corresponding to the inspection result. The policy inspecting unit 220 may select a policy to be applied by referring to a transmitter zone and a receiver zone sent from the zone controlling unit 230. The policy inspecting unit 220 may be a physical device or a function on a virtual machine. For example, as a function within a router device, the policy inspecting unit 220 and the zone controlling unit 230 may be implemented in a single physical device. The policy inspecting unit 220, in the control plane CP, receives, from the management information transmitting and receiving unit 170, a policy set related to a zone included in the network domain and receives, from the zone controlling unit 230, zone information (or policy information corresponding to the zone) of a packet to be inspected. Moreover, the policy inspecting unit 220 identifies a policy to be applied based on the zone information of the packet to be inspected, inspects the packet, and takes an action corresponding to the inspection result.

The zone controlling unit 230 controls zones in the user plane UP. The zone controlling unit 230 identifies the transmitter zone and the receiver zone of a packet and sends the identified zone information or information about a corresponding policy to the policy inspecting unit 220. The zone controlling unit 230, in the control plane CP, receives, from the management information transmitting and receiving unit 170, a definition of zones included within the network domain (to which zone each host is included). Moreover, in response to receiving a packet in the user plane UP, the zone controlling unit 230 identifies the transmitter zone and the receiver zone from zone definition information and, together with the policy inspecting unit 220, performs a routing operation. The zone controlling unit 230 sends the zone information (or policy information corresponding to the zone) of the packet to be inspected to the policy inspecting unit 220 in the control plane CP.

The gateway 240 is a relay device that relays communication between an external network (internet, dedicated circuit, etc.) and an internal network (domain), and the gateway 240 protects a network within the domain from an external network. The gateway 240 may be a physical device or a function on a virtual machine. In one typical example, the gateway 240 is a firewall and permits or discards a packet in accordance with a set policy.

### <Configuration of Control Plane>

Each element of the network controlling unit 100 may be a physical device, a function on a virtual machine, or a function on the cloud. Typically, the functions in the control plane UP exist physically on, for example, the same server or cloud, but these functions may be distributed for a security or operational reason. The data storage 110 is a storage unit that stores data collected by the data collecting unit 130. The policy storage 120 is a storage unit that stores a policy set corresponding to a security index.

The data collecting unit 130 collects information pertaining to a host 210 to be monitored. For example, the data collecting unit 130 collects information inside the network, such as authentication information, behaviors, or communication state of the host. The information to be collected is information for estimating a threat and for setting an appropriate policy. The data collecting unit 130 is capable of, for example, communicating with a desired point on the network in the control plane CP and collecting a packet flowing through the point. Furthermore, the data collecting unit 130 is capable of communicating with the host 210 in the control plane CP, and the data collecting unit 130 collects various pieces of information including the processes and the operating state of the host 210 and performs measurement on the network or the host 210 based on the collected information.

The data collecting unit 130 includes an authenticating unit 131 and a preprocessing unit 132. The authenticating unit 131 may acquire authentication information by having an authentication function pertaining to the host 210 or may receive authentication information from an authentication module of the host 210. For example, the authenticating unit 131 performs, as an authentication function, device authentication, user authentication, application authentication of the host 210. The preprocessing unit 132, if necessary, performs preprocessing, such as deletion of unnecessary information or statistical calculation, in order to store collected information into the data storage 110. For example, the preprocessing unit 132, from a collected packet, calculates a traffic rate or extracts a specific field in the header or the payload. The functions such as the authenticating unit 131 and the preprocessing unit 132 may be distributed in an edge (user plane).

The data analyzing unit 140 analyzes collected data and, together with the score calculating unit 150, calculates a security index (may also be referred to simply as an index). For example, the data analyzing unit 140 and the score calculating unit 150 also serve as a calculating unit that calculates a security index. The data analyzing unit 140 calculates, from various pieces of collected data, an index that enables the zone/policy managing unit 160 to select an appropriate zone or policy. Part of the actual calculation of each index is performed by the score calculating unit 150. The data analyzing unit 140 specifies a calculation method and integrates the calculation results. Herein, the data analyzing unit 140 and the score calculating unit 150 may be implemented as a single analysis calculation unit. Furthermore, in a case in which there are many hosts 210 to be monitored, part of the functions of the data analyzing unit 140 may be assigned to the preprocessing unit 132 of the data collecting unit 130, and this may reduce the capacity of the data storage 110 or the amount of communication in the control plane CP.

The data analyzing unit 140 reads out accumulated information from the data storage 110 and acquires, from the external target system information storage 310, target system information, which cannot be obtained from the data storage 110. Moreover, the data analyzing unit 140 acquires, from the zone/policy managing unit 160, information pertaining to the type of a necessary index that allows the zone/policy managing unit 160 to select an appropriate policy and to calculate an index for applying the policy. The data analyzing unit 140 delegates, to the score calculating unit 150, the calculation of, excluding simple information such as authentication success or failure, an index that needs to be calculated separately (an index pertaining to an anomaly level between a plurality of hosts, an anomaly level of a network as a whole, a statistic of the traffic, etc.). The data analyzing unit 140 transmits data for the calculation to the score calculating unit 150 and specifies a calculation method.

As will be described later, the index that the data analyzing unit 140 and the score calculating unit 150 calculate includes a trust score that indicates the reliability of a host and a performance requirement score that indicates the performance requirement level of a network. For example, when the trust score of a certain host has decreased, the trust score of another host having a logical/physical information path with the aforementioned host may be reduced.

The score calculating unit 150, in place of the data analyzing unit 140, calculates various scores of the indices. The score calculating unit 150 includes an analysis engine or a plurality of models for an analysis and calculates the scores with use of the analysis engine or the models. The score calculating unit 150 receives input of not only the authentication information or the host name but also the traffic data itself, text data whose content is unclear, and various other pieces of data to calculate an anomaly level or to extract a feature and calculates a trust score and a performance requirement score. In particular, the score calculating unit 150 calculates the trust score of elements, such as a collection of specific hosts, the entire zone, or a combination of a host and a user, that each do not appear to be anomalous but, when put together, allow for a determination of an anomaly based on their correlative relationship. For example, the score calculating unit 150 calculates a score with use of a statistical technique, a machine learning technique, a data mining technique, or a domain knowledge-based model, such as a kernel principal component analysis, a correlation analysis, change point detection, linear regression, a support vector machine, a neural network, probability distribution regression, stochastic process regression, or a physical model.

The zone/policy managing unit 160 sets a zone and a policy based on a calculated index. The zone/policy managing unit 160 also serves as a determining unit (setting unit) that determines (sets) a zone and a policy. The zone/policy managing unit 160 performs zoning with part of the target to be monitored (e.g., host) used as a reference and sets a security policy to be applied between zones. At that time, the zone/policy managing unit 160 refers to an index received from the data analyzing unit 140 (e.g., at least one of a trust score or a performance requirement) and dynamically updates a zone and a policy while balancing the security and the performance. For example, the zone/policy managing unit 160 may determine a policy so as to restrict communication between a pair of hosts, based on the indices of the pair of hosts (nodes). For example, the zone/policy managing unit 160 sets a policy so as to restrict communication between a pair of hosts more strictly as the value of the trust score or the performance requirement score (or both) of the pair of hosts (nodes) is lower. The zone/policy managing unit 160 has a function of a software defined network (SDN) controller or a virtual local area network (VLAN) controller and sets a zone and a policy with use of such a function.

The zone/policy managing unit 160 receives, from the data analyzing unit 140, an index (index vector) for setting a zone or a policy. The zone/policy managing unit 160 retrieves a policy set from the policy storage 120 and, if necessary, adds a new policy element to the policy set. The zone/policy managing unit 160, with use of the received index, performs clustering of part of preset targets to be monitored (such as hosts) and sets a zone. The zone/policy managing unit 160 sets a policy to be applied to each zone with use of the policy set. In other words, the zone/policy managing unit 160 groups together targets to be monitored into a zone based on the collected information and updates a policy for each zone. The zone/policy managing unit 160 groups targets into a zone such that hosts (nodes) with close policies to be updated are placed in the same zone. Furthermore, the data analyzing unit 140 recalculates an index (trust score) of each zone in accordance with the zones each determined to have close policies, and the zone/policy managing unit 160 determines policies to be applied within a zone and between zones based on the index calculated for each zone.

The management information transmitting and receiving unit 170 transmits or receives management information (control information) of the zone/policy managing unit 160 in the control plane CP. The management information transmitting and receiving unit 170 sends the zone information and the policy information set by the zone/policy managing unit 160 to the display device 320 or the zone/policy setting device 340. The zone/policy setting device 340 can adjust the notified content. The management information transmitting and receiving unit 170 transmits the zone information and the policy information to be applied by the zone/policy managing unit 160 to the gateway 240 or the zone controlling unit 230. If the zone/policy setting device 340 has updated the content of the policy storage 120, or if the control device 330 has changed the method of managing or a parameter in zones and policies, the management information transmitting and receiving unit 170 and the zone/policy managing unit 160 receive and process such a change.

### <Network Control Method>

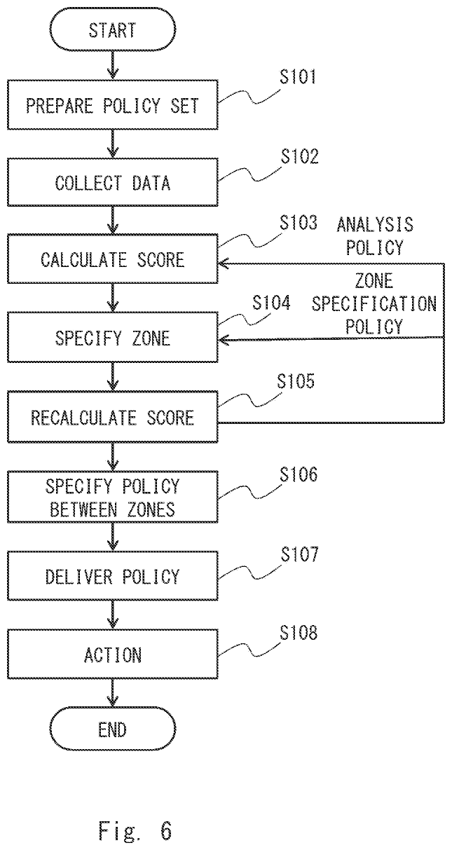

FIG. 6 illustrates a control method (operation example) of the network system according to the present example embodiment. In the present example embodiment, a trust score and a performance requirement score are calculated from data for an analysis (data associated with a host), zone division and policies are determined while balancing trade-offs between the trust score and the performance requirement score, and the scores are recalculated after the zone division to adjust the policies.

As illustrated in FIG. 6, the network controlling unit 100 prepares a policy set in advance (S101). A policy set that includes a plurality of policies is stored, in advance, in the policy storage 120. The policy set defines how the strictness of a communication permission is raised in accordance with the state of a threat in each zone. The policy storage 120 stores, in the policy storage 120, indices and policies associated with each other. For example, an index having a higher value is associated with a policy with a strong communication restriction, and an index having a lower value is associated with a policy with a weak communication restriction.

Next, upon the network starting to operate, the network controlling unit 100 collects data (S102). The data collecting unit 130 collects information for determining a threat from the network or the host and stores the collected information into the data storage 110 after performing necessary preprocessing on the collected information. The data collecting unit 130 collects data periodically in the control plane CP while the network is in operation. For example, the data collecting unit 130 may increase the frequency of collecting data or the minuteness of collection targets, if the index (trust score) of each zone is low. For data with high reliability, lowering the frequency of collecting such data can reduce the communication or the processing overhead.

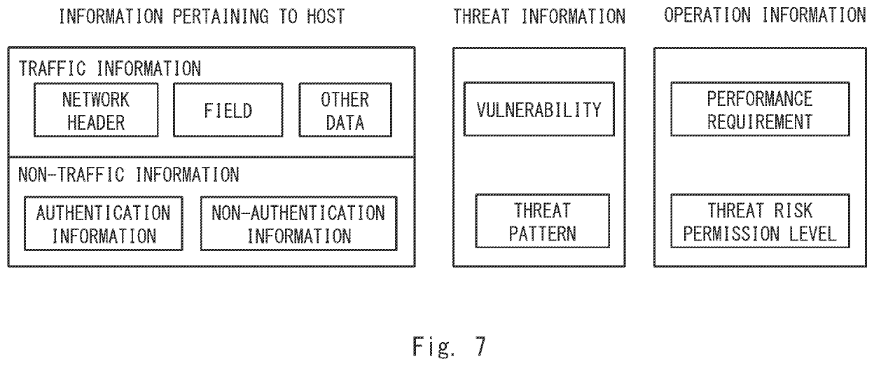

FIG. 7 illustrates a specific example of data that the network controlling unit 100 collects (monitors). The data collecting unit 130 acquires these pieces of data from the user plane UP in the control plane CP, but for data that the data collecting unit 130 cannot acquire, the data analyzing unit 140 may acquire such data from the outside, such as from the target system information storage 310.

In the present example embodiment, a target of an action (permission, discarding, transferring, etc.) of a policy is a packet in the traffic. However, as illustrated in FIG. 7, information to be monitored is not limited to traffic information and includes, for example, non-traffic information, threat information, or operation information.

Information pertaining to a host (node) includes traffic information and non-traffic information and is acquired from the user plane UP. Traffic information is information pertaining to traffic at the host to be monitored and includes information about the network header, information about fields, and other pieces of data. The information about the network header is information included in the header of a packet and is, for example, a MAC address, an IP address, a protocol type, a port number, or routing information. The information about fields is information included in the payload of the packet and is, for example, a known field (data length, sequence ID, random number, time, certificate, host ID, user ID, device ID, application function ID, access destination ID, query ID, response ID, written content, readout content, text data), unknown data (binary), or data in which part of the above is encrypted. The other pieces of data include, for example, the traffic itself or a history of information about the network header or the fields described above.

Non-traffic information is information other than the traffic at the host to be monitored and includes authentication information or non-authentication information. The authentication information is information necessary for authentication and is, for example, host authentication information for authenticating a host, device authentication information for authenticating a device, application authentication information for authenticating an application, or a method for such authentication. Non-authentication information is information other than the authentication information and is, for example, a traffic statistic (transmission rate, RTT, transmission time distribution, transmission order, etc.), an encryption method, a position of a device, a user's contract information, an event such as application installation, process information of a CPU, a memory, or the like, file access information, the state of a lock of a room in which a device is installed, physical operation information affecting a device, or a history of such information.

Threat information and operation information are acquired from the target system information storage 310, a vulnerability database, or the like. The threat information is information pertaining to a threat that is not limited to a host and includes information about the vulnerability or information about a threat pattern. The information about the vulnerability is information about a security hole or the like and includes, for example, vulnerability information of an application, vulnerability information of a device, vulnerability information of a service, or vulnerability information of an authentication method or of an encryption method. The information about a threat pattern is information of an attack pattern that is not limited to a security hole (the information may be included in the vulnerability) and is, for example, a payload pattern that can pose a threat, an application that can pose a threat, a device that can pose a threat, a service that can pose a threat, a user that can pose a threat, an IP address or a MAC address that can pose a threat, or a location or a nation that can pose a threat.

The operation information is information pertaining to an operation of the network system and includes information about the performance requirement or information about the threat risk permission level. The information about the performance requirement is, for example, a configuration of the overall network, an actual connection (e.g., hosts that appear to be independent but exist in the same virtual machine), a communication amount requirement for each slice or domain, or a low-latency requirement. The information about the threat risk permission level is, for example, acceptability/performance of a security response or damage/permissibility expected at a time of an incident.

Next, the network controlling unit 100 analyzes the collected data and calculates a score (index) (S103). The data analyzing unit 140 analyzes a threat within the network based on the collected data. The data analyzing unit 140 basically performs a threat analysis periodically, but if the data analyzing unit 140 is notified of detection of a threat from an edge, such as the policy inspecting unit 220, the data analyzing unit 140 analyzes the threat promptly. Furthermore, the data analyzing unit 140 calculates a score based on an analysis policy, such as the frequency of data acquisition in the control plane or the frequency of policy updates (for each zone). Information about the analysis policy may be acquired from the result of recalculating the score described later (S105).

The data analyzing unit 140 turns the threat into a score in cooperation with the score calculating unit 150. Specifically, the data analyzing unit 140 calculates a plurality of numerical values related to the elements included in the traffic information to be inspected and expresses the numerical values in an index vector (security requirement score). For example, an index vector includes the score of a host, the score between the host and another host, or the score between the zone (the host) and another zone. For the calculation, traffic information collected in the past and other pieces of information are used. The following is an example of the index to be calculated.
Example of a first component of the index vector: the security requirement score of a host A
Example of a second component of the index vector: the security requirement score of communication from a zone F to a zone G
Example of a third component of the index vector: the security requirement score of a protocol P

The data analyzing unit 140 receives information pertaining to the type of the index to be output from the zone/policy managing unit 160. For example, in a case in which the data analyzing unit 140 has user authentication information but the zone/policy managing unit 160 does not require an index concerning the user, the data analyzing unit 140 uses the user information or the like to calculate a related security requirement score as in the example described below.

Examples of information to be used to calculate the example of the first component of the index vector described above (related to the host A):
user information, user authentication information, an authentication method, or a region related to the host A
application information, application authentication information, and an authentication method related to the host A
vulnerability information of the authentication method

In order to obtain the index vector from the information related to each element of the index vector, the data analyzing unit 140 calculates the trust score that indicates the reliability (inverse of the threat level) of each element of the index vector and the performance requirement score that indicates the performance requirement in the operation. In one example, the calculation may be performed through the following equation, in which the index vector v, the trust score vector Trust, the performance requirement score vector Performance, and the coefficient vectors aₜ and aₚ are used to weigh each element. The calculation may be performed with use of any functional form other than the following equation.

[Math. 1]

v=—(aₜ×Trust+aₚ×Performance) (1)

### <Example of Method of Calculating Trust Score>

The data analyzing unit 140 calculates the reliability (trust score) pertaining to each index with use of the authentication information pertaining to the authentication operation of the host, the threat information pertaining to the vulnerability of the host, or the behavior information pertaining to the (normal) behavior of the host, as described with reference to FIG. 7. The behavior information includes a result obtained as the data analyzing unit 140 has analyzed the normality level or the anomaly level of a behavior of the host from the traffic information or the non-traffic information. For example, based on the authentication information, the data analyzing unit 140 adds a fixed trust score of 100 if the authentication has been performed properly, adds a fixed trust score of 50 if the authentication has failed, or adds a trust score of −10 if any vulnerability is present in the authentication method. Furthermore, the data analyzing unit 140, for example, adds a value ranging from −10 to 10 to the trust score in accordance with the calculated anomaly level of a behavior. For example, an analysis algorithm, such as an anomaly detection algorithm, may be required separately. The data analyzing unit 140 delegates part of such complex calculation to the score calculating unit 150 and specifies a model or a parameter.

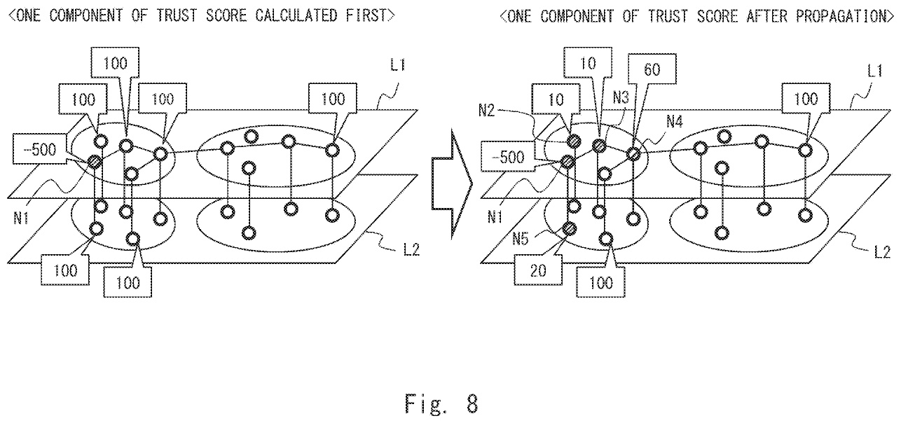

Furthermore, the data analyzing unit 140 may raise or lower the trust score based on a desired element. For example, the data analyzing unit 140 may reduce the trust score in accordance with the time at which the data for the calculation has been collected. Furthermore, the data analyzing unit 140 may calculate the trust score of a host based on the trust score of another host connected to the host via a physical or logical information path. In this case, the data analyzing unit 140 may reduce the trust score of the node in accordance with the reduction rate of the trust score of another node. FIG. 8 illustrates an example in which the trust score is propagated to be reduced. Specifically, the data analyzing unit 140 takes the presence of an actual connection into consideration as much as possible as one element when calculating the trust score. The data analyzing unit 140 performs a calculation to propagate (the inverse of) the trust score in accordance with the amount of actual connection that has not been taken into consideration in the calculation of the trust score the first time, such as that hosts are located at physically close positions, that hosts are on different virtual machines but on the same server, that the communication amount is large, or that the policy is not strict. Typically, the data analyzing unit 140 sets a graph representing an actual connection with each host serving as a node in the propagation calculation and performs the calculation in accordance with, for example, a diffusion equation with the reduction rate set at each edge. In the example shown in FIG. 8, when the trust score of the node N1 has reached −500, the trust scores of the nodes N2 and N3 connected directly with the node N1 through an actual connection are each reduced by 90 to become 10. Furthermore, as for the node N4 connected to the node N3, the reduction amount is set smaller than that of the node N3, and the trust score is reduced by 40 to become 60. Moreover, as for the node N5 of the slice L2 corresponding to the node N1 of the slice L1, the trust score is reduced by 80 to become 20.

### <Example of Method of Calculating Performance Requirement Score>

The data analyzing unit 140 calculates the performance requirement score (the degree by which the security requirement should be lowered) pertaining to each index with use of the operation information pertaining to the operation of the network or the traffic information pertaining to the traffic in the network, as described with reference to FIG. 7. The calculation method is substantially the same as the method used to calculate the trust score, but the propagation calculation or the like is not performed.

Herein, the data analyzing unit 140 may output the result of calculating the index (the security requirement score) collectively in the form of an index vector as in the equation described above. Alternatively, the data analyzing unit 140 may output the result in an extended vector with (the negative value) of the trust score, (the negative value of) the performance score, and (the negative value of) the trust score after the diffusion calculation each being a separate element.

Next, the network controlling unit 100 specifies a zone based on the calculated scores (S104). The zone/policy managing unit 160 determines a policy (or policy candidate) based on the calculated scores and determines a zone based on the determined policy (or determined policy candidate). The zone/policy managing unit 160 determines a zone such that hosts (nodes) with close policies are included in the same zone. The zone/policy managing unit 160 determines a zone configuration through, for example, a threshold determination or clustering based on the threat expressed in scores or results of other analyses, so that the risk of increase of damage is reduced while maintaining the performance of communication and management. For example, the zone/policy managing unit 160 performs clustering of scores and determines a zone based on the result of the clustering. For example, the zone/policy managing unit 160 uses, as a clustering algorithm, a k-NN technique, a k-means technique, DBS-CAN, mixture distribution regression, nonparametric Bayes, a hierarchical Bayesian model, density ratio estimation, autoencoder, variational autoencoder, representation learning, embedding, or a combination of any of the above. Furthermore, the zone/policy managing unit 160 specifies a zone based on a zone specification policy that includes a zone coupling/dividing policy (for each zone in the previous instance). Information about the zone specification policy may be obtained from the result of recalculating the scores described below (S105).

Next, the network controlling unit 100 recalculates the scores based of the specified zone (S105). In response to a zone specified by the zone/policy managing unit 160, the data analyzing unit 140 recalculates the index (trust score) for each zone. Specifically, after setting a zone, the zone/policy managing unit 160 sends information about the set zone to the data analyzing unit 140 before setting a policy. The data analyzing unit 140 receives this information about the zone from the zone/policy managing unit 160 and recalculates the index with this zone information taken into account. For example, the data analyzing unit 140 calculates an index for each new zone or an index for each pair of zones. The calculation method is similar to the method employed at S103 described above. Herein, if there is no change in the performance requirement score, the data analyzing unit 140 may recalculate only the trust score. The data analyzing unit 140 transmits the final index vector to the zone/policy managing unit 160.

Next, the network controlling unit 100 specifies a policy between zones (S106). The zone/policy managing unit 160 selects a policy between zones based on the recalculated scores. The zone/policy managing unit 160 selects a policy with the scores of each zone taken into account. An administrator adjusts a zone or a policy, if necessary, via the display device 320 or the zone/policy setting device 340.

Next, the network controlling unit 100 delivers the specified policy (S107). The zone/policy managing unit 160 transmits the zone information to the zone controlling unit 230 of the edge and transmits the policy information of each zone to the policy inspecting unit 220. The zone/policy managing unit 160 transmits zone/policy information necessary for a rough inspection of communication across domains to the gateway 240. The zone/policy managing unit 160, for example, issues a certificate, if necessary.

Next, an action is executed in accordance with the policy for each zone (S108). In the network (edge), upon a packet being transmitted from a host or the internet, the zone controlling unit 230 determines the transmitter zone and the receiver zone, and the policy inspecting unit 220 inspects the packet in accordance with a combination of the zones and lets the packet pass as is or discards the packet. Thus, an attack packet is prevented from being spread.

<Example of Scenario in which Security Risk Increases>

With the network system and the control method described above, an increase in the security risk can be handled as described below.
If a device within a network has installed malware, in response to the detection of the installation of a suspicious application at a host, the trust score is reduced based on the vulnerability information or the like of the host. In that case, the host in which the installation has been detected is isolated into a zone different from the zones of the other hosts until an administrator performs a check, and the policies between the zones are changed to raise the security level. Since another host of the same device in a different slice or a neighboring host that frequently communicates with the host may have also been affected already, the zone is subdivided, and the security level is raised slightly.
If a device is infected with malware and the device is to transmit a packet that spreads the infection, for example, even if the malware itself cannot be detected, if an anomalous behavior of a packet has been found from the traffic information or the like, this case can be handled in a manner similar to that in the case described above.
If a remote connection is established through an attack on the vulnerability of an operating system (OS) and an attacker tries to access a device via a malicious application, an anomalous behavior of a host can be detected based on the traffic information or the like in this case as well, and thus this case can be handled in a manner similar to that in the case described above.
If a malicious user has raised his or her authority by operating a PC, for example, and if the authority has been raised in an environment in which such a change in the authority is not normally made, the anomaly level increases based on the behavior or the like, and the trust score of the host and the user is reduced. In this case, the zone is subdivided after the authority has been raised to raise the security level, and the accessible range is restricted. Thereafter, the zone and the security level are returned to their original settings, upon the approval by an administrator or the acquisition of additional information through the passage of time.

### Advantageous Effects of First Example Embodiment

As described above, in the present example embodiment, in the zoning of security zones in a network, the zones are determined by the clustering of security indices. Specifically, the trust score (of each entity) and the performance requirement score (of each entity or each pair of zones) are calculated, and the clustering is performed. For example, entities of close policies are grouped together, and a zone is determined as a creek. This configuration can facilitate management of policies while performing rigorous policy control. As a zone is subdivided and policies are controlled specifically only when necessary, the visibility of the entire network becomes better, and more appropriate policies can be set.

Furthermore, in the present example embodiment, when a security index is calculated, the trust score is propagated in accordance with a physical or logical connection. Specifically, a strict policy is set to an access not only from a suspicious entity but also from its surrounding entity. This configuration can raise the security level with the possibility of a risk taken into consideration. An attack via another slice can be prevented while maintaining performance corresponding to a slice or a virtual segment.

Furthermore, in the present example embodiment, after a zone is specified based on a calculated security index, the security index is recalculated for each new zone. In other words, the trust score is recalculated for each new zone after the zones are confirmed. This configuration makes it possible to adjust policies with the suspiciousness of overall behaviors taken into consideration. For example, in one conceivable case, although a single entity is not suspicious but a correlation of behaviors of a plurality of entities may be suspicious. When such behaviors are to be reflected onto detailed policies, the suspiciousness needs to be evaluated for each combination of entities. However, the number of combinations of entities is exponential. Therefore, with a focus only on a combination of zones, an attempt to newly identify a suspicious relationship is made.

It is to be noted that the present disclosure is not limited to the foregoing example embodiments, and modifications can be made, as appropriate, within the scope that does not depart from the technical scope and spirit.

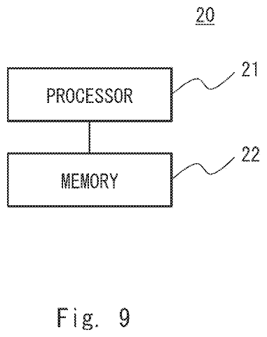

Each of the components according to the foregoing example embodiments may be constituted by hardware or software or both. Each of the components may be constituted by a single piece of hardware or software or by a plurality of pieces of hardware or software. Each of the devices and the functions (processes) may be implemented by a computer 20 that includes a processor 21, such as a central processing unit (CPU), and a memory 22 serving as a storage device, as illustrated in FIG. 9. For example, a program for performing a method (control method) according to an example embodiment may be stored in the memory 22, and each of the functions may be implemented as the processor 21 executes the program stored in the memory 22.

This program can be stored and provided to a computer with use of various types of non-transitory computer-readable media. Non-transitory computer-readable media include various types of tangible storage media. Examples of such non-transitory computer-readable media include a magnetic recording medium (e.g., a flexible disk, a magnetic tape, or a hard-disk drive), a magneto-optical recording medium (e.g., a magneto-optical disk), a CD-ROM (read-only memory), a CD-R, a CD-R/W, or a semiconductor memory (e.g., a mask ROM, a programmable ROM (PROM), or an erasable PROM (EPROM), a flash ROM, or a random-access memory (RAM)). Furthermore, the program may be supplied to a computer with use of various types of transitory computer-readable media. Examples of such transitory computer-readable media include an electric signal, an optical signal, or an electromagnetic wave. A transitory computer-readable medium can supply the program to a computer via a wired communication line, such as an electric wire or an optical fiber, or via a wireless communication line.

Thus far, the present disclosure has been described with reference to the example embodiments, but the present disclosure is not limited by the foregoing example embodiments. Various modifications that a person skilled in the art can appreciate can be made to the configuration and the details of the present disclosure within the scope of the present disclosure.

Part or the whole of the foregoing example embodiments can also be expressed as in the following supplementary notes, which are not limiting.

### (Supplementary Note 1)

A network control apparatus comprising:
collecting means for collecting data pertaining to a node included in a network;
calculating means for calculating a security index pertaining to a threat of the node based on the collected data; and
determining means for determining a zone of the node based on the calculated security index.

### (Supplementary Note 2)

The network control apparatus according to Supplementary Note 1, wherein the security index includes a trust score that indicates a reliability of the node.

### (Supplementary Note 3)

The network control apparatus according to Supplementary Note 2, wherein the calculating means calculates the trust score based on any one of authentication information pertaining to an authentication operation of the node, threat information pertaining to a vulnerability of the node, or behavior information pertaining to a behavior of the node.

### (Supplementary Note 4)

The network control apparatus according to Supplementary Note 2 or 3, wherein the calculating means calculates the trust score of the node based on a trust score of an other node connected to the node via a physical or logical information path.

### (Supplementary Note 5)

The network control apparatus according to Supplementary Note 4, wherein the calculating means reduces the trust score of the node in accordance with a reduction rate of the trust score of the other node.

### (Supplementary Note 6)

The network control apparatus according to any one of Supplementary Notes 1 to 5, wherein the security index includes a performance requirement score that indicates a performance requirement level of the network.

### (Supplementary Note 7)

The network control apparatus according to Supplementary Note 6, wherein the calculating means calculates the performance requirement score based on either of operation information pertaining to an operation of the network or traffic information pertaining to traffic of the network.

### (Supplementary Note 8)

The network control apparatus according to any one of Supplementary Notes 1 to 7, wherein the determining means determines a policy based on the security index and determines the zone based on the determined policy.

### (Supplementary Note 9)

The network control apparatus according to Supplementary Note 8, wherein the determining means determines the zone such that nodes of which the policies are close are included in the same zone.

### (Supplementary Note 10)

The network control apparatus according to Supplementary Note 8 or 9, wherein the determining means performs clustering of the security indices and determines the zone based on a result of the clustering.

### (Supplementary Note 11)

The network control apparatus according to any one of Supplementary Notes 8 to 10, wherein the determining means determines the policy so as to restrict communication between a pair of the nodes, based on the security indices of the pair of the nodes.

### (Supplementary Note 12)

The network control apparatus according to any one of Supplementary Notes 8 to 11, wherein
the calculating means calculates a security index for each zone in accordance with the determined zone, and
the determining means determines a policy to be set for the zone, based on the security index calculated for each zone.

### (Supplementary Note 13)

A network system comprising:
a node included in a network; and
a network control apparatus controlling the network,
wherein the network control apparatus includes
   collecting means for collecting data pertaining to the node,
   calculating means for calculating a security index pertaining to a threat of the node based on the collected data, and
   determining means for determining a zone of the node based on the calculated security index.

### (Supplementary Note 14)

A network control method comprising:
collecting data pertaining to a node included in a network;
calculating a security index pertaining to a threat of the node based on the collected data; and
determining a zone of the node based on the calculated security index.

### (Supplementary Note 15)

A non-transitory computer-readable medium storing a program for causing a computer to execute processing of:
collecting data pertaining to a node included in a network;
calculating a security index pertaining to a threat of the node based on the collected data; and
determining a zone of the node based on the calculated security index.

### REFERENCE SIGNS LIST

1 NETWORK SYSTEM
10 NETWORK CONTROL APPARATUS
11 COLLECTING UNIT
12 CALCULATING UNIT
13 DETERMINING UNIT
20 COMPUTER
21 PROCESSOR
22 MEMORY
100 NETWORK CONTROLLING UNIT
110 DATA STORAGE
120 POLICY STORAGE
130 DATA COLLECTING UNIT
131 AUTHENTICATING UNIT
132 PREPROCESSING UNIT
140 DATA ANALYZING UNIT
150 SCORE CALCULATING UNIT
160 ZONE/POLICY MANAGING UNIT
170 MANAGEMENT INFORMATION TRANSMITTING AND RECEIVING UNIT
200 NETWORK COMMUNICATION UNIT
210 HOST
220 POLICY INSPECTING UNIT
230 ZONE CONTROLLING UNIT
240 GATEWAY
310 TARGET SYSTEM INFORMATION STORAGE
320 DISPLAY DEVICE
330 CONTROL DEVICE
340 ZONE/POLICY SETTING DEVICE

What is claimed is:

1. A network control apparatus comprising:
at least one memory storing instructions, and
at least one processor configured to execute the instructions stored in the at least one memory to;
collect data pertaining to a node included in a network;
calculate a security index pertaining to a threat of the node based on the collected data; and
determine a zone of the node based on the calculated security index.

2. The network control apparatus according to claim 1, wherein the security index includes a trust score that indicates a reliability of the node.

3. The network control apparatus according to claim 2, wherein the at least one processor is further configured to execute the instructions stored in the at least one memory to calculate the trust score based on any one of authentication information pertaining to an authentication operation of the node, threat information pertaining to a vulnerability of the node, or behavior information pertaining to a behavior of the node.

4. The network control apparatus according to claim 2, wherein the at least one processor is further configured to execute the instructions stored in the at least one memory to calculate the trust score of the node based on a trust score of an other node connected to the node via a physical or logical information path.

5. The network control apparatus according to claim 4, wherein the at least one processor is further configured to execute the instructions stored in the at least one memory to reduce the trust score of the node in accordance with a reduction rate of the trust score of the other node.

6. The network control apparatus according to claim 1, wherein the security index includes a performance requirement score that indicates a performance requirement level of the network.

7. The network control apparatus according to claim 6, wherein the at least one processor is further configured to execute the instructions stored in the at least one memory to calculate the performance requirement score based on either of operation information pertaining to an operation of the network or traffic information pertaining to traffic of the network.

8. The network control apparatus according to claim 1, wherein the at least one processor is further configured to execute the instructions stored in the at least one memory to determine a policy based on the security index and determine the zone based on the determined policy.

9. The network control apparatus according to claim 8, wherein the at least one processor is further configured to execute the instructions stored in the at least one memory to determine the zone such that nodes of which the policies are close are included in the same zone.

10. The network control apparatus according to claim 8, wherein the at least one processor is further configured to execute the instructions stored in the at least one memory to perform clustering of the security indices and determine the zone based on a result of the clustering.

11. The network control apparatus according to claim 8, wherein the at least one processor is further configured to execute the instructions stored in the at least one memory to determine the policy so as to restrict communication between a pair of the nodes, based on the security indices of the pair of the nodes.

12. The network control apparatus according claim 8, wherein
the at least one processor is further configured to execute the instructions stored in the at least one memory to calculate a security index for each zone in accordance with the determined zone, and
determine a policy to be set for the zone, based on the security index calculated for each zone.

13. A network system comprising:
a node included in a network; and
a network control apparatus controlling the network,
wherein the network control apparatus includes
at least one memory storing instructions, and
at least one processor configured to execute the instructions stored in the at least one memory to;
collect data pertaining to the node,
calculate a security index pertaining to a threat of the node based on the collected data, and
determine a zone of the node based on the calculated security index.

14. A network control method comprising:
collecting data pertaining to a node included in a network;
calculating a security index pertaining to a threat of the node based on the collected data; and
determining a zone of the node based on the calculated security index.

15. A non-transitory computer-readable medium storing a program for causing a computer to execute processing of:
collecting data pertaining to a node included in a network;
calculating a security index pertaining to a threat of the node based on the collected data; and
determining a zone of the node based on the calculated security index.
